(19) United States
(12) Patent Application Publication
(10) Pub. No.: US 2005/0039931 A1
(43) Pub. Date: Feb. 24, 2005

(54) Tunnel first safety device

(76) Inventor: Erich Koerber, Lutzenberg (CH)

Correspondence Address: Flynn Thiel Boutell & Tanis, 2026 Rambling Road, Kalamazoo, MI, 49008-1631, US

(21) Appl. No.: 10/476,930

(22) PCT Filed: Apr. 9, 2002
(86) PCT No.: PCT/EP02/03960

(30) Foreign Application Priority Data
Apr. 10, 2001 (DE) 10117908.1

(51) Int. Cl. A62C 37/10

(52) U.S. Cl. 169/64; 169/60

(57) ABSTRACT

In order to increase the safety of tunnels when a fire occurs, the tunnel is divided into sections (A) which are then separated from each other by curtains (1). Each section (A) is provided with at least one fire sensor (2) which closes said curtains (1) in said section (A) if a fire breaks out.

This invention relates to a safety device for fires in tunnels.

There has recently been a dramatic increase in the number of tunnel fires with human casualties.

Numerous elaborate measures have been proposed for diminishing the consequences, for example building rescue tunnels parallel to the existing tunnels.

The problem of the invention is to provide a simply constructed safety device for preventing the disastrous consequences of tunnel fires.

This is obtained according to the invention with the safety device characterized in claim 1. The subclaims render advantageous embodiments of the invention.

According to the invention, curtains that can be closed in the event of a fire are provided in the tunnel at intervals of for example 50 meters to 200 meters. This permits the tunnel portion to be closed off when the fire sensor has detected a fire in said portion. The curtain is made of incombustible material, for example a cloth of fibers of inorganic material.

The inventive safety device is thus characterized by its simplicity.

The fire sensor can be a smoke detector and/or heat sensor. The curtains can be mounted on the tunnel ceiling in a rolled up or folded state.

However, the curtains are preferably drawn across the roadway or, in the case of a railroad or cable railway tunnel, across the tracks.

The curtains are for this purpose suspended on the tunnel wall in the drawn up, i.e. folded, state, preferably in a joint or similar recess provided, for example milled, in the tunnel wall.

The recess or other space in which the drawn up curtains are located can be closable by flaps to protect the curtains from soiling.

Each curtain can consist of a plurality of parts, in particular two parts or halves, that in the drawn up or folded state are disposed on or in one or the other tunnel wall. For closing, the two curtain parts are drawn in the direction of the opposite tunnel wall. In the extended state the curtain parts can thus extend from one tunnel wall to the other, i.e. form a double-walled curtain, but they can also extend only halfway across the tunnel, preferably so as to overlap in the middle of the tunnel.

Closing of the curtains is effected by a motor, for example an electric motor. However, a pyrotechnic motor can also be provided for automatically closing the curtains for example. The motor can also open the flaps protecting the curtains from soiling.

The curtains preferably consist in particular in the lower area of strips extending from above to below, i.e. vertically, to permit them to be drawn over vehicles and similar objects in the tunnel. The width of the strips can be for example 20 centimeters to 50 centimeters. The strips are preferably formed so as to overlap in the extended state of the curtain. To increase the protection, two curtain parts can also be provided on each side of the tunnel that form two also be provided on each side of the tunnel that form two curtain portions spaced one behind the other in the drawn up state of the curtain.

For drawing up, the curtains are guided on slide rails provided on or in the area of the tunnel ceiling. If a plurality of parts are used for each curtain, multiple-track slide rails are preferably used.

In the event of a fire in one tunnel portion, the curtains of said portion are closed. This contains the danger sector. Persons located in the danger area thus have time to leave the danger area through the curtain. The danger area is thus limited by the curtains to an easily surveyed sector. Outside said area the smoke gases that have developed constitute a substantially lower danger for the individual persons.

To suck off the smoke gases arising in the event of a fire, each tunnel portion has at least one device for sucking off vitiated air. The vitiated air suction device can be formed for example by an opening in the tunnel ceiling that leads to the vitiated air duct of the tunnel. Preferably, the connection from each tunnel portion to the vitiated air duct is closable by a flap or similar shut-off device.

In the event of a fire the fire sensor can thus open the flap of the vitiated air suction device in the portion with the fire, while all or at least some of the flaps of the vitiated air suction devices of the other tunnel portions can be closed by the fire sensor. The smoke gases formed can thus be selectively sucked off. The closing of the flaps of the other tunnel portions causes the total suction effect to be concentrated on the portion with the fire.

The curtains are formed so that, in the closed state, they close off the upper area of the tunnel more tightly than the lower tunnel area. This ensures that fresh air sucked into the portion with the fire by the vitiated air suction device flows into the lower area of the curtains, so that any injured persons lying on the tunnel floor have more chance of escaping the smoke gases. It is known that 80 percent of tunnel victims die from smoke gases and not from burns. Since the individual curtains are for example 100 meters apart, air is not sucked in strongly enough to cause additional kindling of the fire.

The inventive safety device guarantees that rescue vehicles and fire trucks can penetrate from outside to the portion with the fire without being exposed to appreciable smoke development or heat, which substantially facilitates rescue measures as well as extinguishing and salvage operations.

Further, the tunnel portions can each be provided with a traffic light, whereby in the event of a fire the fire sensor switches all traffic lights located before the portion with the fire in the driving direction to red, and all traffic lights located after the portion with the fire to green. The traffic lights switched red cause the total following traffic to be not only stopped but at the same time broken up, since the individual cars or groups of cars stop at intervals, e.g. of 100 meters, corresponding to the portions. The broken up following traffic permits operational units to penetrate to the scene of the accident more easily. This breaking up also permits vehicles to turn around more easily to leave the tunnel in the opposite direction. The traffic lights switched green permit those vehicles to move away that are located after the portion with the fire in the driving direction.

Further, a loudspeaker or intercom can be mounted in each portion for guiding persons in the right direction.

Further, each portion can be provided with a video camera so that the circumstances of the accident can be immediately detected and the corresponding rescue measures taken.

To prevent false trips, a plurality of fire sensors are preferably provided in each portion. Thus, the curtains are only closed before and after each portion in the driving direction if for example at least two fire sensors detect a fire. Also, each tunnel portion can be provided with an impact switch for closing the curtains.

The actuation of the individual curtains, the individual sensors, the actuating devices for the flaps on the vitiated air suction device and the dust flaps for the drawn up curtains as well as the video cameras can be checked regularly by a central computer.

The inventive safety device permits tunnels to be retrofitted at reasonable cost. In the event of a fire the relevant tunnel portion can be closed off within seconds. Persons located in the danger area can flee through the preferably strip-shaped curtain and find safety. Persons in the tunnel, outside the portion with the fire, are protected from smoke and heat even if they remain seated in their vehicles. Smoke gases are sucked off from the source of the fire from above so that any injured persons on the tunnel floor are spared from smoke gases for a certain time. Operational units can immediately penetrate to the danger area and begin rescue since the heat and source of the fire can be kept under control in the relevant portion. Also, operational units can penetrate into the portion with the fire only to rescue people and then immediately leave it. Thus, each person can move out of the danger area within seconds when passing the curtain. Moreover, the power of the vitiated air suction device can be increased in the event of a fire.

In the following an embodiment of the inventive safety device for tunnel fires will be explained in more detail by way of example with reference to the drawing, in which:

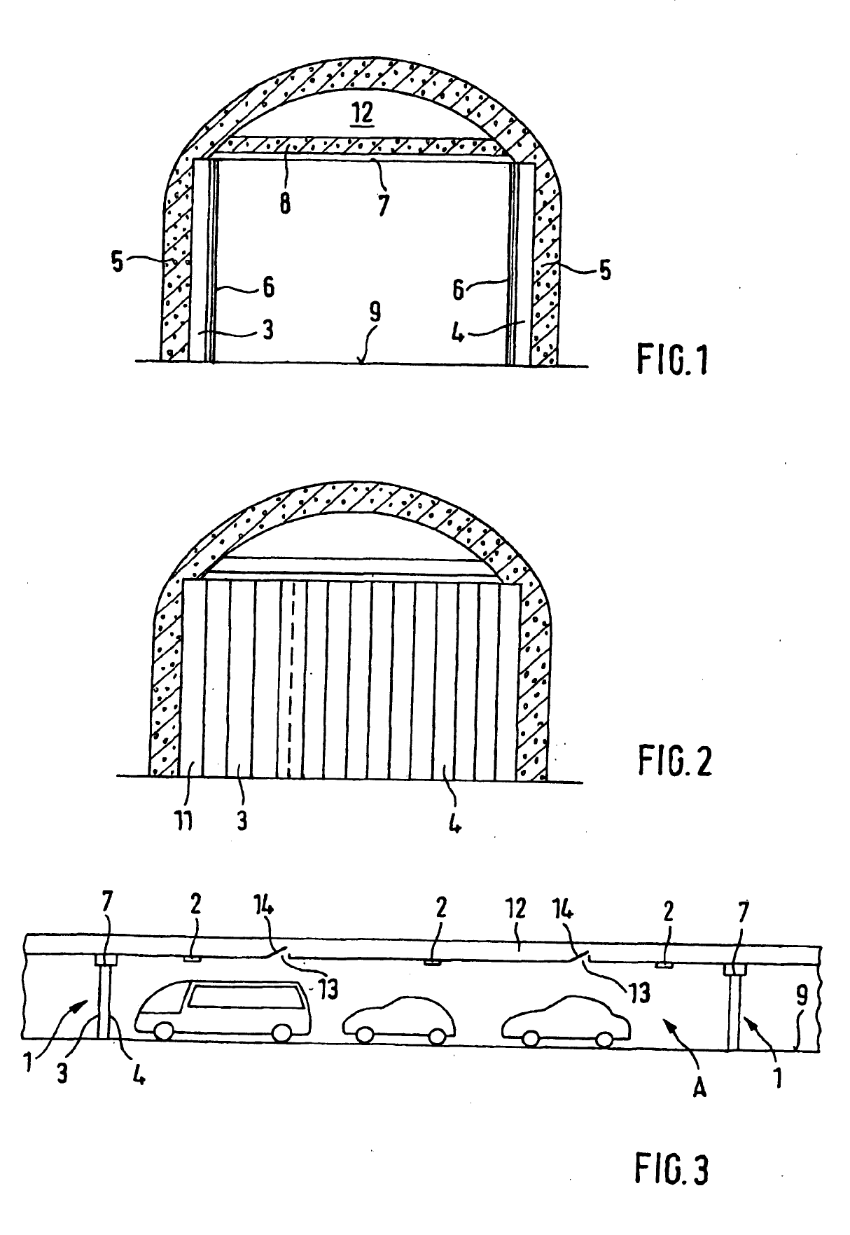

FIGS. 1 and 2 show a cross section through a tunnel with the curtain open and closed; and

FIG. 3 shows a longitudinal section through a portion of the tunnel with closed curtains.

According to FIG. 3, the tunnel is divided into portions A that are separable from each other by fireproof curtains 1 mounted before and after portion A in the driving direction. In each portion A fire sensors 2 are provided on the ceiling that close curtains 1 in the event of a fire in portion A.

According to FIG. 1, each curtain 1 consists of two curtain parts. Drawn up curtain parts 3, 4 are disposed in recesses 5 on the left and right in the tunnel wall.

Recesses 5 are closable by flaps 6 to protect curtain parts 3, 4 from soiling.

Curtain parts 3, 4 are guided on slide rails 7 on tunnel ceiling 8.

For closing, curtain parts 3, 4 are drawn across roadway 9 (FIG. 2) e.g. with a motor not shown, for example an electric motor or similar automatically acting device not shown. That is, curtain parts 3, 4 are extended in the direction of the other tunnel wall so that they overlap in the middle, as shown by the dash line in FIG. 2. Curtain parts 3, 4 consist of strips 11 that are 30 centimeters wide for example.

Curtain parts 3, 4 can also extend in the closed state across total roadway 9 so as to form a double-walled curtain comprising curtain parts 3 and 4, as to be seen in FIG. 3.

Vitiated air duct 12 with ventilators and similar vitiated air suction devices not shown extends in the tunnel above tunnel ceiling 8. Vitiated air duct 12 is connected with portion A by suction openings 13. Suction openings 13 are closable with flaps 14.

In the event of a fire, fire sensors 2 drive the motors for actuating curtains 1 of relevant portion A and the actuating devices for dirt flaps 6, causing flaps 6 to open and curtain parts 3, 4 to be drawn in the direction of the other tunnel wall for closing curtains 1. At the same time, sensors 2 cause flaps 14 to open for vitiated air suction in portion A with the fire, while the flaps are closed on the suction openings of the other portions, at least the portions adjacent the fire portion.

1. A safety device for fires in tunnels, characterized in that the tunnel has portions (A) that are separable from each other by curtains (1), each portion (A) being provided with at least one fire sensor (2) that causes the curtains (1) of the portion (A) to be closed in the event of a fire.

2. A safety device according to claim 1, characterized in that the curtains (1) are closed by a motor that is driven by the fire sensor. (2)

3. A safety device according to claim 1, characterized in that the curtains (1) are drawn across the roadway (9) for closing.

4. A safety device according to claim 3, characterized in that the drawn up curtains (1) are disposed on the tunnel wall.

5. A safety device according to claim 4, characterized in that the drawn up curtains (1) are disposed in a recess (5) in the tunnel wall.

6. A safety device according to claim 1, characterized in that the drawn up curtains (1) are disposed in spaces closable by curtain flaps (6), the curtain flaps (6) being opened in the event of a fire.

7. A safety device according to claim 1, characterized in that the curtains (1) consist of strips (11) extending from above to below.

8. A safety device according to claim 7, characterized in that the strips (11) overlap in the extended state of the curtains (1).

9. A safety device according to claim 1, characterized in that the curtains are formed to be fireproof.

10. A safety device according to claim 1, characterized in that each curtain (1) consists of at least two curtain parts (3, 4) on each tunnel side that are drawn in the direction of the other tunnel side for closing.

11. A safety device according to claim 1, characterized in that each curtain consists in the closed state of two portions (3, 4) spaced one behind the other.

12. A safety device according to claim 1, characterized in that the curtains are guided on slide rails (7) provided in the area of the tunnel ceiling (8).

13. A safety device according to claim 1, characterized in that the curtains (1) are formed in such a way as to close off the upper tunnel area more tightly than the lower tunnel area.

14. A safety device according to claim 1, characterized in that each tunnel portion (A) is provided with at least one device for vitiated air suction.

15. A safety device according to claim 14, characterized in that the vitiated air suction device has a connection to the vitiated air duct (12) of the tunnel, said connection being closable with a shut-off device (14).

16. A safety device according to claim 15, characterized in that in the event of a fire the shut-off device (14) of the vitiated air device in the portion (A) with the fire is opened by the fire sensor (2) and the shut-off devices of the vitiated air suction devices of the other portions are at least partly closed.

17. A safety device according to claim 1, characterized in that the tunnel portions (A) are each provided with a traffic light, whereby in the event of a fire the fire sensor causes all traffic lights before the portion (A) with the fire to be switched to red and all traffic lights after the portion (A) with the fire to be switched to green.
